(19) United States
(12) Patent Application Publication
(10) Pub. No.: US 2001/0014399 A1
(43) Pub. Date: Aug. 16, 2001

(54) CONDUCTIVE UV-CURABLE EPOXY FORMULATIONS

(76) Inventor: STANLEY J. JASNE, YORKTOWN HEIGHTS, NY (US)

Correspondence Address: S. MATTHEW CAIRNS, DIKE BRONSTEIN ROBERTS & CUSHMAN, 130 WATER STREET, BOSTON, MA, 02109

(21) Appl. No.: 09/104,601

(22) Filed: Jun. 24, 1998

Related U.S. Application Data
(63) Continuation-in-part of application No. 08/806,804, filed on Feb. 26, 1997.

(51) Int. Cl. B32B 27/38

(52) U.S. Cl. 428/413; 525/523; 525/524; 525/533; 523/427

(57) ABSTRACT

A UV curable composition comprising a UV curable epoxy-functional essentially solvent free reactant, and a UV curing agent, and a conductive filler, said conductive filler present at a selected concentration, particle size distribution and shape, wherein said composition, subsequent to cure, provides a deposited conductive film whose conductivity is controlled by said conductive filler concentration, particle size distribution and shape.

### CROSS-REFERENCE TO RELATED APPLICATIONS

This application is a continuation-in-part of U.S. patent application Ser. No. 08/806,804, filed Feb. 26, 1997.

### FIELD OF THE INVENTION

This invention is related to the use of conductive UV-curable epoxy formulations as coatings for substrates. More particularly, the formulations themselves are all UV-curable, and can be made as high elongation low moduli materials. In addition, the present invention relates to UV curable flame retardant materials, for use in the electronics industry, wherein such formulations can be made flame retardant or even self-extinguishing. The formulations herein also in alternative embodiment demonstrate excellent electrical insulation capabilities, and critically compensate for coefficient of thermal expansion mismatches between components in electronic board applications.

### BACKGROUND OF THE INVENTION

Epoxy resins are generally characterized by the possession of more than one oxirane ring per molecule. The epoxy group itself may lie within the body of the molecule or in a terminal position. Epoxy groups are characterized as highly strained, and therefore, are quite reactive to many substances, particularly nucleophiles and proton donors. Such reactions allow chain extension and/or crosslinking to occur without the elimination of small molecule by-products. That being the case, epoxy formulations tend to exhibit a lower curing shrinkage than many other types of thermosetting plastics.

A very wide range of epoxy resins have been reported in the literature, most of which deal with the rigidity and high modulus behavior of these systems, in a highly crosslinked or thermoset configuration. In formulating such systems, the non-epoxy part of the system may be aliphatic, cycloaliphatic or highly aromatic hydrocarbon or it may be non-hydrocarbon and quite polar. It may contain unsaturation. Similar remarks also apply to the chain extension/cross- linking agents, so that cross-linked products of great diversity may be obtained. In practice, however, the commercial scene has been dominated by the reaction products of bisphenol-A and epichlorohydrin which account for the majority of market share. For a short yet excellent review of epoxy chemistry, attention is directed to “Plastics Materials”, by J. A. Brydson, Butterworths, 5th Edition, 1989.

For a number of applications, however, epoxy resins may be considered to have a variety of disadvantages. These disadvantages include high viscosity, high cost, and too high a rigidity for specific applications. The resins therefore have been modified by incorporation of compounds known as dilutents and fillers, and for surface coating applications, blends with other resins.

More specifically, dilutents, by definition, are free flowing liquids incorporated to reduce viscosity and simplify handling. Typical dilutents, which are also known as “reactive” dilutents, include phenyl glycidyl ether, butyl glycidyl ether and octylene oxide. Fillers include sand, metal powders, metal oxide fillers, wire wool and asbestos. Other additives include non-reactive types, fall into the general category of conventional phthalates and phosphates. Alternatively, polymeric additives have been employed, particularly low molecular weight polyamides from dimer acids, low molecular weight polysulphides, polyamines and the polyglycol diepoxides.

Specific examples of modified epoxy systems have also been widely reported in the patent literature, and the following are noted: 1. European Patent Application No. 94119996 describes a one component epoxy resin composition. The polyepoxide resins are said to comprise an epoxidized resin based on a polyglycidyl ether of a phenolic type compound, and a latent amine curative; 2. European Patent Application No.88810851, entitled “Flexibilized Epoxy Resin Compositions” describes an epoxy resin in combination with a polyester which is carboxy terminated. The composition is described as useful as a surface coating or as an adhesive. In addition, heat curing or curing by means of combined treatment with actinic radiation and heat is disclosed; 3. European Patent Application No. 92810598 discloses a two component epoxy resin adhesive system comprising an epoxy component containing at least one aromatic multi-functional epoxy resin and a liquid elastomer component comprising a liquid co-polymer based on butadiene and at least one ethylenically unsaturated comonomer and a liquid oligomer reaction product of a polyamine and a dimer acid and a liquid aromatic or aliphatic polyamine. The compositions were said to have a high glass transition temperature, flexibility, and fast curing; 4. U.S. Pat. No. 5,318,808 discloses compositions for photocurable coatings. The compositions are said to comprise (a) an epoxidized vegetable oil, (b) a low molecular weight epoxy resin, (c) a photoinitiator for cationic polymerization and (d) a wax. Processes for making and using and coatings are also disclosed as are containers coated according to the invention; 6. U.S. Pat. No. 5,516,824, entitled “Solvent-free Laminating Adhesive Composition,” reports on a laminated adhesive comprising an epoxidized block copolymer in combination what is identified as a “tackifying” resin, compatible with the epoxidized block copolymer material. The epoxidized block copolymer is said to contain blocks of isoprene and butadiene, with varying molecular weight; 6. U.S. Pat. No. 5,545,510, entitled “Photodefinable Dielectric Composition Useful in the Manufacture of Printed Circuits” defines a composition and process for fabricating circuitry packages. The composition is said to comprise a carboxy functional resin, an acrylate oligomer, an epoxy functional resin, a butadiene nitrile resin, and a photoinitiator. The composition is claimed in connection with fabricating circuitry packages; 7. U.S. Pat. No. 5,258,459, entitled “Resin Compositions for Coating and Electrodeposition Coating Composition Containing the Same,” discloses a resin composition obtained by reacting an epoxy resin, a butadiene-acrylonitrile copolymer having carboxyl groups or amino groups at both terminals of the molecule and (c) a bifunctional mononuclear phenolic compound, such as resorcinol. The coating compositions are described as having high adhesion to metal substrates, good flexibility, chipping resistance and low temperature properties; 8. U.S. Pat. No. 5,075,379, entitled “Rubber/Diamine Blends for Use in Curing Epoxy Resins,” describes the use of a blend of diaminoisopropylbenzene and an amine terminated butadiene nitrile liquid rubber for curing epoxy resins. The blend is described as producing a rubber toughened epoxy resin having improved tensile properties; 8. U.S. Pat. No. 4,482,660, entitled “Prepreg for Making A Composite having High Elongation . . . ”, discloses a prepreg formulated from an epoxy resin, the product of an epoxy resin and a butadiene-acrylonitrile copolymer having carboxyl groups on those terminals of the copolymer chain, and an amine curing agent. The composition produced is said to have high tensile elongation and heat resistance; and 9. U.S. Pat. No. 5,420,202 entitled “Epoxidized Low Viscosity Rubber Toughening Modifiers for Cycloaliphatic Epoxy Resins”, describes a toughened cycloaliphatic epoxy resin comprising a curable cycloaliphatic epoxy resin, an epoxidized low viscosity polydiene polymer, and a curing agent.

The above review of basic epoxy formulations is relevant to the present invention, as the present invention relates to the use of high elongation and low moduli epoxy systems, in electronics applications, which has heretofore been unreported. However, before considering the details of the invention herein, it is worth noting that in general, electronic applications demand adhesive products, of which epoxies are excellent candidates, that possess a number of properties in addition to adhesive strength and compatibility with substrate surfaces. In this regard, attention is first directed to Circuits & Assembly, August 1995, wherein the inventor of this application points out that with respect to present theory and practice for surface-mount technology, including flip-chip devices and ball grid arrays (BGA's), such theory and practice has emphasized the use of what is known as a rigid underfill encapsulant to maintain the viability of the device through temperature and humidity cycling.

Such stiff high modulus underfill materials are of course rigid. They are typically filled polymers (such as epoxies), and are designed to have a coefficient of thermal expansion (CTE) that approximates the other materials that they are in contact. Hence, during temperature cycling, it is expected that the encapsulant will expand and contract at a similar rate as the solder, ceramic, and chip, all of which have different CTE's making this approach difficult in reality. Due to the fact that the expansion is the same, little stress is generated on the complete package. However, a rigid underfill does not inherently possess a mechanism to dissipate stresses that occur during temperature and humidity cycling and/or mechanical vibration. That is, if the enapsulant is more rigid than the solder or other components, then stresses will be transferred into the solder bumps, joints and/or chips, potentially leading to failures.

Also, rigid organic polymers have different coefficient of thermal expansions (CTE's) above and below the Tg of the polymer. Thus, if the use or testing temperature of the devices varies through the Tg of the polymer, then stresses can be built up on the device by continually cycling through the Tg of the encapsulant. A constant rise in CTE through the use temperature range may ultimately prove to induce less stress on the system. In the final analysis, stress can be defined as: modulus multiplied by CTE. Different values of stress are therefore obtained below Tg and then from Tg to some elevated temperature.

What the above review therefore reveals is that with regards to underfill materials, and as part of the unique inventive concept herein, there has been a long-standing need for low moduli materials, to prevent damage during temperature cycling. More specifically, low modulus materials, in the case of surface mount technology, would provide a mechanism for mechanical and thermal shock to be dissipated. The desirable properties of such a systems would include, in addition to an extremely low modulus, superior elongation, low-moisture pickup and transport, minimal shrinkage upon cure, rapid thermal cure, a CTE above that of the solder, a thermally conductive system, superior adhesion, and a Tg below or above device operating temperatures.

In addition, and with regards to flexible circuitry, there has been a similar long-standing demand for high elongation/low moduli type materials, as a replacement resin for various applications therein such that the flexible circuit design is propertly protected by a suitable coating.

Towards this end, e.g., silicon adhesives have been proposed, and reference is made to the September/October 1996 issue of “Advanced Packaging”, pages 30-31. Attention is also directed to Advanced Packaging, Winter 1993, and The International Journal of Microcircuits and Electronics Packaging, Vol. 19, No 3, Third Quarter 1996. Finally, attention is also directed to the IEEE Transactions on Components, Packaging and Manufacturing Technology, Part A, Vol. 17, No. 3, September 1994, which describes UV curable coatings for electronic components.

Furthermore, reference is made to the Journal of Coatings Technology, Vol. 66, No. 838, November 1994, which specifically reports on epoxidized polybutadiene as a reactive prepolymer for cationically curable photosensitive compositions. The coatings therein were said to posses high flexibility along with good adhesion to aluminum, steel and glass by adequate adjustment of the formulation compositions. However, this reference does not suggest and does not set moduli limits, as contemplated herein, nor the development of a low modulus system to deal with the above referenced problems of dissimilar CTE's in surface-mount electronic and coating systems and coating formulations.

All of the formulations noted above also have the disadvantage in that none of the resins therein collectively have the combined characteristics of being UV-curable along with a low moduli values, in addition to resistance to elevated temperature, good electrical insulation capabilities, and superior adhesion, and as noted, the ability for the polymeric system to compensate for CTE mismatches in electronic board temperature cycling. In addition, none of the prior art resins are both UV curable and flame retardant.

As a consequence therefore, it is an object of this invention to develop such characteristics for a thermoset polymer, specifically in an epoxy-based formulation, and thereby provide an improved coating material for components in electronic boards so that coefficient of thermal expansion mismatches which exist as between board components are compensated, and stresses are minimized.

It is also an object of this invention to provide an electronic board assembly itself, which contains a coating that does not impart stress to the board/device itself, and which formulation is based upon a thermoset polymeric formulation that exhibits low moduli, cures by UV irradiation (but can be made thermally curable or dual curable), contains no silicon or urethane linkages, essentially solvent free, has good electrical insulation characteristics, and shows minimal shrinkage during the curing process.

### SUMMARY OF THE INVENTION

A UV curable composition comprising a UV curable epoxy-functional essentially solvent free reactant, and a UV curing agent, said composition, subsequent to cure, exhibiting a modulus of less than about 50,000 psi, and an elongation of greater than about 3.0%.

In process form, the present invention describes a process for providing a low moduli underfill encapsulant which comprises the steps of mixing from 1 to 99 parts of a UV curable epoxy-functional essentially solvent free reactant with with 99 to 1 parts of a component selected from the group consisting of epoxidized polybutadienes, thermoplastic elastomers, epoxidized oils, long chain polyols, other epoxy monomers/oligomers, and mixtures thereof, followed by addition of a UV curing agent and applying the mixture to a substrate to provide a coated substrate and exposing said coated substrate to light of wavelength from about 100 to 700 nm wherein the mixture is substantially polymerized by exposure to said light, and said polymerized mixture has a modulus of less than about 50,000 psi and an elongation of greater than about 3.0%.

In still further embodiment, the present invention also relates to a low moduli thermoset encapsulant which comprises an epoxy based thermoset resin with which dissipates stresses developed as between the encapsulant and other materials contacted due to differences in coefficient of thermal expansion of said other materials and said flexible thermoset encapsulant.

Furthermore, the present invention also relates to the preparation of a low moduli thermoset coating which comprises an epoxy based resin characterized in that the resin is UV curable, and has a moduli of less than about 50,000 psi, and an elongation of greater than about 3.0%. In addition, said coating can be made flame retardant or self-extinguishing upon addition of a flame retardant additive selected from the group consisting of brominated compounds, phosphorous compounds, and antimony compounds.

Finally, the present invention also relates to novel UV curable epoxy based systems which contains a conductive particulate filler thereby providing a conductive film subsequent to cure.

### BRIEF DESCRIPTION OF THE DRAWINGS

FIG. 1 illustrates in block diagram format the overall synthetic scheme and options therein for producing the UV curable low moduli epoxy formulation of the present invention.

### DETAILED DESCRIPTION OF THE PREFERRED EMBODIMENTS

The present invention in a first embodiment comprises a UV curable composition comprising a UV curable epoxy-functional essentially solvent free reactant, and a UV curing agent, said composition, subsequent to cure, exhibiting a modulus of less than about 50,000 psi, and an elongation of greater than 3.0%. Preferably said UV curable composition includes a component is selected from the group consisting of epoxidized polybutadienes, thermoplastic elastomers, epoxidized oils, long chain polyols, other epoxy monomers/oligomers, and mixtures thereof.

Those skilled in the art will appreciate that by incorporating the above referenced components, the moduli values will be lowered, and elongational properties will be improved. In broad embodiment, therefore, the level of the UV curable epoxy-functional essentially solvent free reactant will vary between 1-99% (wt) and the above referenced component will vary between 99-1%, in order to achieve the desired reduction in modulus and increase in elongational properties. Preferably, however, the UV curable reactant is present at a level of less than about 40% (wt), the thermoplastic elastomer is present at a level of less than about 5% (wt), the epoxidized oils are present at a level of less than about 40% (wt.), the long chain diol is present at a level of up to about 66% (wt) and the other epoxy monomers/oligomers are present at a level of up to about 50% (wt). In addition, the anhydride compound is preferably present at a level of about 30-50% (wt.), which anhydride assists in the curing of the formulation.

Preferably, the UV curable epoxy-functional essentially solvent free reactant is formed by reaction of bisphenol A and epichlorohydrin and the UV curing agent generates acid in the presence of UV light. More preferably, the UV curing agent is an acid generating onium salt compound. In additional, and in optional embodiment the formulation may contain an anhydride functional compound such as polysebasic acid anhydride or methyl(tetrahydrophthalic anhydride). Such anhydrides also cure in the presence of UV light with the UV curing agent herein described.

In process form, the present invention can be described as a process for providing a low moduli underfill encapsulant which comprises the steps of mixing from 1 to 99 parts of a UV curable epoxy-functional essentially solvent free reactant with 99 to 1 parts of a component selected from the group consisting of epoxidized polybutadienes, thermoplastic elastomers, epoxidized oils, long chain polyols, other epoxy monomers/oligomers, and mixtures thereof, followed by the addition of a UV curing agent, and applying the mixture to a substrate to provide a coated substrate and exposing the coated substrate to light of wavelength from about 100 to 700 nm wherein the mixture is substantially polymerized by exposure to said light. By such process. preferably, the modulus developed is less than about 50,000 psi.

In addition the present invention herein includes what can be termed a low moduli thermoset encapsulant which comprises an epoxy based thermoset resin with which dissipates stresses developed as between the encapsulant and other materials contacted due to differences in coefficient of thermal expansion of said other materials and said flexible thermoset encapsulant. Preferably, in such context, the thermoset encapsulant modulus is less than about 50,000 psi. In analagous fashion, the present invention also provides a low moduli thermoset coating which comprises an epoxy based resin characterized in that the resin is UV curable, and has a moduli of less than about 50,000 psi, further characterized by an elongation of greater than about 3.0%.

Table I sets out the various representative formulations which have been found exemplary and preferable in accordance with the invention disclosed herein. For the formulations presented in Table I, it is to be noted that the samples were all polymerized by a UV light source that was broad banded and centered around 365 nm. Table II lists the measured mechanical properties.

The following is representative of the epoxide formulations used.

The following materials were mixed (i.e. rolled) in a wide mouth jar for ½ hr: 40 grams of Epon 828 (Shell Chemical Company); 100 grams of polybutadiene (Elf Atochem); 100 grams Heloxy 505 (Shell Chemical Company). Then, 2.4 grams of CD 1010 (Sartomer Corp. an onium salt latent acid generator) was added and the reaction mixture was stirred for an additional 5 minutes.

Aerosil 200 (thixotropic silica gel) from Degussa was added as appropriate to thicken the same for obtaining a variable coating thickness. The samples were coated onto Mylar or release paper and polymerized by exposure to actinic radiation fom a Dymax EC 5000 exposure tool with a broad-band radiation centered around 365 nm for 20 to 45 seconds.

Accordingly, the formulations which appear below in Table I were prepared according to the above general procedure, with the various amounts and optional reagents as indicated. Following Table I is Table II which presents the various mechanical properties (tensile strength, elongation at break, modulus and hardness values) of the formulations so prepared.

TABLE I
FORMULATIONS

| SAMPLE | Heloxy | Heloxy | PS | Vicoflex | | Heloxy | | RP | KF- | | HT |
|---|---|---|---|---|---|---|---|---|---|---|---|
| # | 605 | 505 | PA | 9010 | 828 | 48 | Ricotuff | 30 | 188 | LD | 221 |
| 1 | 41.6 | 41.6 | | | 16.7 | | | | | | |
| 2 | 41.6 | | | 41.6 | 16.7 | | | | | | |
| 3 | | | | | | 2.3 | 48.9 | 48.9 | | | |
| 4 | 50 | | 16.7 | | 33.3 | | | | | | |
| 5A | 25 | | 8.3 | | 16.7 | | | | 50 | | |
| 5B | 25 | | 8.3 | | 16.7 | | | | 50 | | |
| 6 | | | 20 | | 40 | | | | 40 | | |
| 7 | 31.2 | 31.2 | | | 12.5 | | | | 25 | | |
| 8 | 20.3 | 20.3 | | | 8.15 | | | | 51.2 | | |
| 9 | 41.6 | | | | 16.7 | | | | | | |
| 10 | 34.7 | | | 34.7 | 13.9 | | | | | 11.9 | |
| 11 | 34.7 | | | 34.7 | 13.9 | | | | | 11.9 | |
| 12 | 34.7 | | | 34.7 | 13.9 | | | | | 11.9 | |
| 13 | 40 | 40 | | | 20 | | | | | | |
| 14 | | | | | | | | | | | 100 |
| 15 | | | | | | | | | 26.8 | | 73.2 |
| 16 | 16 | 16 | | | 8 | | | | 50 | | |
| 17 | 36.3 | 36.3 | 9.2 | | 18.2 | | | | | | |
| 18 | 25.01 | | 8.3 | | 16.66 | | | | 50 | | |
| 19 | 16.26 | 29.27 | | | 19.5 | | | | | 9.75 | |

TABLE II
PROPERTIES

| SAMPLE # | T.S. (psi) | Elg. Break (%) | Mod. (psi) | Shore A |
|---|---|---|---|---|
| 1 | 377 | 19.6 | 1926 | 85 |
| 2 | 626 | 30.1 | 2079 | 85 |
| 3 | 213 | 17.8 | 1196 | 70 |
| 4 | 720 | 17.95 | 4011 | 72 |
| 5A | 52.5 | 61.0 | 86 | 55 |
| 5B | 52.5 | 61.0 | 86 | 55 |
| 6 | 205 | 78.4 | 261 | |
| 7 | 137 | 21.5 | 637 | |
| 8 | | | | |
| 9 | 264 | 19.5 | 1353 | |
| 10 | 443 | 22.4 | 1977 | |
| 11 | 343 | 24.4 | 1405 | |
| 12 | 184 | 18 | 1022 | |
| 13 | 144 | 8.4 | 1714 | |
| 14 | 287 | 3.7 | 7756 | |
| 15 | 335 | 7.5 | 4466 | |
| 16 | 4.9 | 36.7 | 13.3 | |
| 17 | 193 | 17.1 | 11.28 | |
| 18 | 13.4 | 28.2 | 47.5 | |
| 19 | 367 | 76.4 | 480 | |

As can be seen from Table I, the preferred epoxy resin is Epon 828, which is available from Shell, which is an epoxy resin formed from bisphenol A and epichlorohydrin and equivalents are available from Dow. It is to be noted that equivalents to such epoxy resins are available from Dow. In addition, other epoxy resins which have been employed include Heloxy 505, Heloxy 84, and Heloxy 48, which are also epoxy resins (glycidyl ethers of castor oil), and again, available form Shell. Limonene dioxide (LD) is also employed, available from Elf Atochem, which is an aliphatic epoxy acting to dissolve the thermoplastic elastomer. Vicoflex 9010 is an epoxidized linseed oil/methyl ester. Ricotuff 1100/A is a maleated polybutadiene. KF-188 is a polyol. LD is reference to limonene dioxide. HT-221 is High Temp 220, a commercially available epoxy resin.

The preferred reactive polybutadienes include hydroxy terminated epoxidized polybutadienes, typical of which are Poly BD 600 and Poly BD 605 available from Elf Atochem. However, in the broad scope of the invention herein, it will be appreciated by those skilled in the art that the hydroxy termination can be supplied sources other than a polybutadiene product. For example, such alternative sources would include a hydroxy terminated polyester. In addition, the invention herein in preferred embodiment makes use of Ricotuff 1100/A. Such maleated polybutadiene was found particularly useful in further improving elongation and lowering of the modulus.

Other reactive components include polysebasic polyanhydride, available from Lonza, as well as methyltetrahydrophthalic anhydride. Such components act to increase elongation and decrease modulus and improve thermal stability. Furthermore, a liquid polyisoprene polymer can be incorporated herein, at levels of about 1-10%, and said liquid polyisoprene also acts to reduce moduli values.

With regard to the optional use of a thermoplastic elastomer as a further component to the formulation described herein, it has been found preferable to employ Europrene SOL T 190 or SOL T-166 or KRATON FG which are all styrene based thermoplastic elastomers, all of which are particularly useful in for increasing elongational properties.

Finally, in all of the formulations, it is preferable to employ a small amount of an adhesion promoter (about 1%), and in this regard, “Dynasylan Glymo” has been found as a preferred promoter, available from Huls. For example, and with reference to Table I, Sample #20 contains about 0.8% adhesion promotor, in addition to the components identified therein.

In addition, the preferred UV curable acid-generating curing agent was an onium salt, preferred of which include 1:2 mixtures of Sartomer 1012/LD or Sartomer 1010 or Sartomer 1011 or equivalents available from Union Carbide. Furthermore, while the above formulations provide suitable properties for a low moduli coating application, it has been found as a preferred alternative that in some cases, post curing, via thermal curing techniques, is desirable. That is, in certain systems where thickness becomes significant, both UV and thermal cure can be preferably employed. With respect to such dual curing, those skilled in the art will appreciate that in the case of such thick coatings, UV curing may only be relatively efficient at or near the surface, and in such cases, a conventional thermal curing process can be applied to insure total cure through-out the cross-section of such thick coating formulations.

With reference to Table II, it can be seen therein that a true low moduli UV curable epoxy formulation has been developed, with associated elongational values. As shown therein, by formulating according to Table I, modulus values as low as 47.5 psi, and upwards of 8000 psi, have been obtained. In addition, elongations of at least about 3.0% are herein obtained. Furthermore, those skilled in the art will appreciate that by adjusting the formulation, moduli values can be increased. That is, in accordance with the basic concept herein, of developing an essentially solvent free UV curable epoxy resin, moduli values can be increased incrementally to 10,000 psi, 20,000 psi, 30,000 psi, 40,000 psi, 50,000 psi, and up, until the appropriate moduli is obtained. Towards such end, one increases the amount of U.V. curable epoxy resin relative to, e.g., the epoxidized polybutadienes, thermoplastic elastomers, epoxidized oils, long chain polyols, and other epoxy monomers/oligomers, while maintaining UV curing capability.

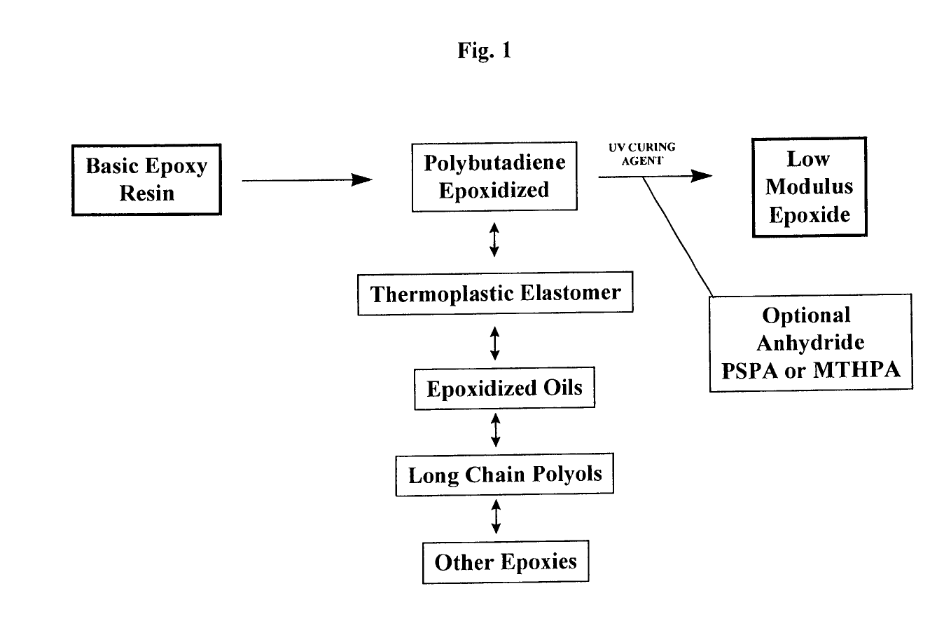

Attention is directed to FIG. 1, which illustrates the basic overall approach for preparing the low moduli epoxy systems of the present invention. As illustrated therein, the basic epoxy resin can be combined with, e.g, epoxidized polybutadienes, thermoplastic elastomers, epoxidized oils, long chain polyols, and/or other epoxy monomers/oligomers, or mixtures thereof. Accordingly, those skilled in the art will recognize that one aspect of the invention herein is to select a component which will, together with the UV curable epoxy-functional essentially solvent free reactant, provide the low moduli materials disclosed herein. The amount of such component, as previously noted, has been found to vary as between 1-99 parts, relative to 99-1 part of the basic epoxy reactant. Also illustrated in FIG. I is that a UV curing agent is included, and optionally, an anhydride functional compound which provides, in addition to the epoxy functionality, another chemical moiety for curing.

With regard to the utility of the present invention, the low moduli formulations herein, apart from utility for dealing with CTE mismatches between components and the board, will also have broad utility in armature and cartridge attachment, buffer coats, chip bonding, chip on board, coil bonding, conformal coatings, glob tops, high flow IC cards, hybrid module potting, interlevel dielectrics, LED coatings, magnetic and steppermotor assemblies, optical potting, opto electronics, smart cards, and wire tacking.

In addition, in preferred embodiment, the formulations herein are UV curable low moduli epoxy/polybutadiene combinations, whereas current UV curable systems, as used in the electronic industry, depend upon acrylates, urethanes and silicons. These latter materials are more polar, and hence, the epoxy/polybutadiene formulations herein have better electrical properties and lower moisture absorption than these prior art systems. Furthermore, polymerization of epoxides is a ring opening mechanism and therefore there will be less shrinkage upon cure than with acrylate products. Furthermore the epoxies themselves after crosslinking are resistant to solvents, and the products formulated herein can be dual curable, which allow for thermal post curing.

In addition, as noted in the summary of the invention, also disclosed herein is a UV curable composition which comprises an epoxy-functional essentially solvent free epoxy resin, which is UV curable, which therefore contains a UV curing agent, wherein such composition, subsequent to cure, is substantially flame retardant or self-extinguishing. Below is an example of a preparation that illustrates the preparation of such flame retardant UV curable, epoxy based formulation.

120 grams of Epox 1163 (a brominated bisphenol A) from Shell is melted in an oven at 125 C. To the warm solution was added 120 grams of Heloxy 505 and 50 grams of PHT-4 diol (3,4,5,6-tetrabromo-1,2-benzene dicarboxylic acid; mixed esters with diethylene glycol and propylene glycol) available from Great Lakes Chemical, and stirred until a homogeneous solution was obtained. To 50 grams of this solution was added an additional 5 grams of PHT-4 diol.

In a separate vessel 90 grams of Epoxy 828, 180 grams of Polybutadiene 605 and 120 grams of Heloxy 505 were mixed. 10 grams of this solution were added to the above solution.

To the above mixture (65 grams) was added 2.68 grams of TNPP (trinonylphenyl phosphine) (General Electric Specialty Chemicals) followed by 790 mg of Sartomer 1010 (cationic onium antimony salt). The mixture was then stirred until homogenous. To the rapidly stirring mixture of the above, 2.25 grams of antimony trioxide (United Mineral & Chemical Corp.) and 670 mg of Aerosil 200 (Degussa) was added and mixed vigorously for 15 minutes. The formulation was then degassed under vacuum and coated onto substrates and cured into a film by a 45 sec exposure.

A nominal 50 mil coating was made on Mylar and release paper. When the product was removed from the release paper and held above a flame it did not ignite and self-extinguished. The same coated onto Mylar was exposed to actinic radiation on both sides of the film for a total of 90 seconds (45 seconds on each side). When placed in a flame the sample was self-extinguishing.

A wooden tongue depressor was dipped into the above formulation. The coating was cured by actinic radiation. When placed in a flame the wooden tongue depressor failed to ignite.

As noted above, in further embodiment, the present invention also relates to novel UV curable epoxy based systems comprising a UV curable epoxy-functional essentially solvent free reactant, and a UV curing agent, and a conducitve filler, wherein said conductive filler is present at a selected concentration, particle size distribution and shape, and wherein said composition, subsequent to cure, provides a deposited conductive film whose conductivity is controlled by said conductive filler concentration, particle size distribution and shape. In addition, it has also been determined that the type of UV curable epoxy based system can also effect conductivity.

Accordingly, it has been determined that the various low moduli UV curable systems noted above, as well as various other UV curable epoxy systems with higher moduli values, can be combined with conductive particular fillers as noted above to provide resistance as low as the milliohm range and up to serveral kiloohms as described in the following working examples which appear below. More specifically, resistance of about 500 milliohms or less can be achieved in the conductive films herein. Suitable but by no means limiting conductive fillers preferably include silver or silver flake, copper, aluminum, solder powder, and mixtures thereof. A particularly preferred conductive filler is a silver/solder mixture. Preferred loading of conductive filler is, as noted, is controlled to effect conductivity, and in preferred embodiment is about 50% (wt.) and higher. The following illustrative example is provided:

BASE-POLYMER PREPARATION

| PRODUCT | WT. (GMS) | COMPANY |
|---|---|---|
| PBD 605 | 20.3 | Elf Atochem |
| Heloxy 505 | 20.3 | Shell |
| Epon 828 | 8.15 | Shell |
| K-Flex 188 | 51.2 | King Industries |
| CD1010 | 0.752 | Sartomer |

Preparation.

Mix each of the above by hand. Draw down using draw down bar set at 3-5 mils. Coatings surface either paper or Kapton® (Dupont). Before use the Kapton® was heated at 150° C. for 5 minutes to remove the moisture from the film.

Samples were cured by a 400 watt metal halide lamp system centered at 365 run (Dymas EB 5000-675.9 hrs on the bulb). Cure cycle was either:

45 secs. Exposure—1 minute hold—45 secs. Exposure (A)

45 secs. Exposure (B).

The resistance of the samples was measured using a Keithly model 580 microhm meter using a spring-loaded tip probe.

After UV cure generally a 2-3 mil thick film was obtained: Results are shown below:

| | | | | | Resistance |
|---|---|---|---|---|---|
| Product | Sample # | Substrate | Exposure | Thickness | (milliohms) |
| 1 | 161-3A | Kapton | A | 2 | 7.9 |
| 1 | 161-3B | Paper | A | 2 | 4.5 |
| 1 | 161-4 | Paper | B | 2 | 4 |
| 2 | 162-1 | Paper | B | 2 | 11-15 |
| 2 | 162-2 | Kapton | B | 2 | 26 |

I claim:

1. A UV curable composition comprising a UV curable epoxy-functional essentially solvent free reactant, and a UV curing agent, and a conductive filler, said conductive filler present at a selected concentration, particle size distribution and shape, wherein said composition, subsequent to cure, provides a deposited conductive film whose conductivity is controlled by said conductive filler concentration, particle size distribution and shape.

2. The UV curable composition of claim 1, wherein said conductivity is measured by a resistance of less than about 500 milliohms as measured in said film as deposited.

3. The UV curable composition of claim 2 wherein said resistance is less than about 25 milliohms.

4. The UV curable composition of claim 1 wherein said conductive filler comprises silver flake. copper, aluminum, solder powder and mixtures thereof.

5. The UV curable composition of claim 1 wherein said conductive filler comprises a silver/solder mixture.

6. The UV curable composition of claim 1 wherein said conductive filler is present at a concentration of about 50% (wt) or higher.

7. The UV curable composition of claim 1, wherein said is UV curable composition is additionally capable of thermal cure upon exposure to heat.
